(19) United States
(12) Patent Application Publication
(10) Pub. No.: US 2019/0063116 A1
(43) Pub. Date: Feb. 28, 2019

(54) Vehicle And Its Door Handle Mechanism And Door Outside Handle Mechanism

(71) Applicant: Zhejiang CFMOTO Power Co., Ltd., Hangzhou (CN)

(72) Inventor: Pengfei Zou, Hangzhou (CN)

(21) Appl. No.: 16/109,589

(22) Filed: Aug. 22, 2018

(30) Foreign Application Priority Data
Aug. 25, 2017 (CN) 201721078678.7

(51) Int. Cl. E05B 79/06; E05B 79/20; E05B 79/04; E05B 85/10

(52) U.S. Cl. CPC E05B 79/06; E05B 85/10; E05B 79/04; E05B 79/20

(57) ABSTRACT

The present invention discloses a type of vehicle, the outer door handle mechanism and the door handle mechanism. Wherein, the outer door handle mechanism includes the door skeleton and the outer door handle; the cable and the door lock are arranged on the door skeleton; one end of the cable is connected to the movable lock pin of the door lock; the outer door handle is rotated and arranged on the outside of the door skeleton; one end of the outer door handle is connected to the other end of the cable. In the above outer door handle mechanism, the outer door handle is connected to the door lock by the cable instead of connecting rod structure; the cable can be arranged along any path and kept away from the inner door handle because of high flexibility and plasticity of the cable relative to the connecting rod mechanism, which avoid the inner door handle interfering with the outer door handle and the problem of difficult installation.

### CROSS-REFERENCE TO RELATED U.S. APPLICATION(S)

None.

### FIELD OF THE INVENTION

The present invention relates to the technical field of vehicle structure design, and more particularly, to a type of vehicle, the door handle mechanism and the outer door handle mechanism.

### BACKGROUND OF THE INVENTION

The inner handle and the outer handle are arranged on the inner side and outer side of the door to enable the user to open the door inside and outside the vehicle.

At present, the inner door handle or outer door handle is connected to the lock through the connecting rod mechanism arranged inside the door body. However, because the inner door handle and outer door handle are located in the adjacent position on the door. The connecting rod mechanisms of the inner door handle and outer door handle are easy to be interfered with each other, so it is inconvenient to arrange them.

Therefore, how to provide a type of outer door handle structure to avoid the mutual interference with the inner door handle and reasonably make use of the space inside the door body is technical defect which urgently needs to be solved for those skilled in the art.

### BRIEF SUMMARY OF THE INVENTION

In view of this, the first purpose of the present invention is to provide a type of outer door handle mechanism to avoid the mutual interference with the inner door handle and reasonably make use of the space inside the door body. The second purpose of the present invention is to provide a type of vehicle and its door handle mechanism based on the outer door handle mechanism above.

In order to achieve the above object, the present invention provides the following technical schemes:

A type of door handle mechanism includes:

The door skeleton is provided with the cable and the door lock; one end of the said cable is connected to the movable lock pin of the said door lock;

The outer door handle is rotated and arranged on the outside of the said door skeleton; one end of the said outer door handle is connected to the other end of the said cable.

Preferably, the said outer door handle is the U-shaped handle; the opening end of the said U-shaped handle is rotated and connected to the door skeleton; one side of the opening end of the said U-shaped handle is connected to the other end of the cable; the reset device is arranged between the other side of the opening end of the said U-shaped handle and the said door skeleton.

Preferably, the other end of the said cable is connected to the said U-shaped handle through the cable clip plate; the said U-shaped handle is provided with the connecting part; the said connecting part is provided with the first pass opening that can be passed by the said cable end head; the second pass opening is formed on the said cable clip plate; the said cable core can be passed through the said second pass opening and the end head of the said cable can not be passed through the said second pass opening; the said cable clip plate is coordinated with the said connecting part to make the said second pass opening to be located on one side of the said first pass opening.

Preferably, the limit slot is formed on the said cable clip plate; the said limit slot is coordinated with the said connecting part to make the said first pass opening and the said second pass opening to be aligned with each other.

Preferably, the said U-shaped handle is rotated and arranged on the said door skeleton through the pin shaft; the said pin shaft is passed through both sides of the opening end of the said U-shaped handle to make the said U-shaped handle to be connected to the said door skeleton.

Preferably, the said reset device is the torsion spring; the main body of the said torsion spring is mounted around the said pin shaft; one of the two torsion arms of the said torsion spring is assembled with the said door skeleton and the other is assembled with the said U-shaped handle.

A type of door handle mechanism is characterized in that it includes:

The door skeleton is provided with the door lock with the movable lock pin;

The first cable and the second cable are arranged on the outer side of the said door skeleton; one ends of the said first cable and the said second cable are both connected to the said movable locking pin;

For the inner door handle and the outer door handle, the said inner door handle includes the holding part and the driving part fixedly attached to the said holding part; the said holding part is rotated and arranged on the inner side of the door skeleton; the said driving part is passed through the said door skeleton and connected to the other end of the first cable outside the said door skeleton; the said outer door handle is rotated and arranged outside the said door skeleton and connected to the other end of the said second cable.

A type of vehicle includes the outer door handle mechanism as described in any of the claims 1-6, or the door handle mechanism as described in claim 7.

The outer door handle mechanism provided by the present invention includes the door skeleton and the outer door handle; wherein, the cable and the door lock are arranged on the door skeleton; one end of the cable is connected to the movable lock pin of the door lock; the outer door handle is rotated and arranged on the outside of the door skeleton; one end of the outer door handle is connected to the other end of the cable. In the above outer door handle mechanism, the outer door handle is connected to the door lock by the cable instead of connecting rod structure; the cable can be arranged along any path and kept away from the inner door handle because of high flexibility and plasticity of the cable relative to the connecting rod mechanism, which avoid the inner door handle interfering with the outer door handle and the problem of difficult installation.

In order to achieve the second object, the present invention also provides a type of door handle mechanism including the door handle mechanism as described above. Because the above outer door handle mechanism has the above technical effect, the door handle mechanism provided with this outer door handle mechanism should also have the corresponding technical effect.

Further, the present invention also provides a type of vehicle, which includes the outer door handle mechanism or the door handle mechanism as described above.

### BRIEF DESCRIPTION OF THE DRAWINGS

In order to describe the technical scheme more clearly in the existing technology or the embodiment of the present invention, the drawings required for the implementation of the existing technology or the embodiment of the present invention are briefly introduced in the following, obviously, the drawings below are some embodiments of the present invention, for the ordinary technical personnel in the art, you can also get other drawings according to these drawings at the premise of without giving creative labor.

FIG. 1 is the schematic view showing the structure of the outer door handle mechanism provided by the embodiment of the present invention;

FIG. 2 is the explosion view showing the structure of the outer door handle mechanism provided by the embodiment of the present invention;

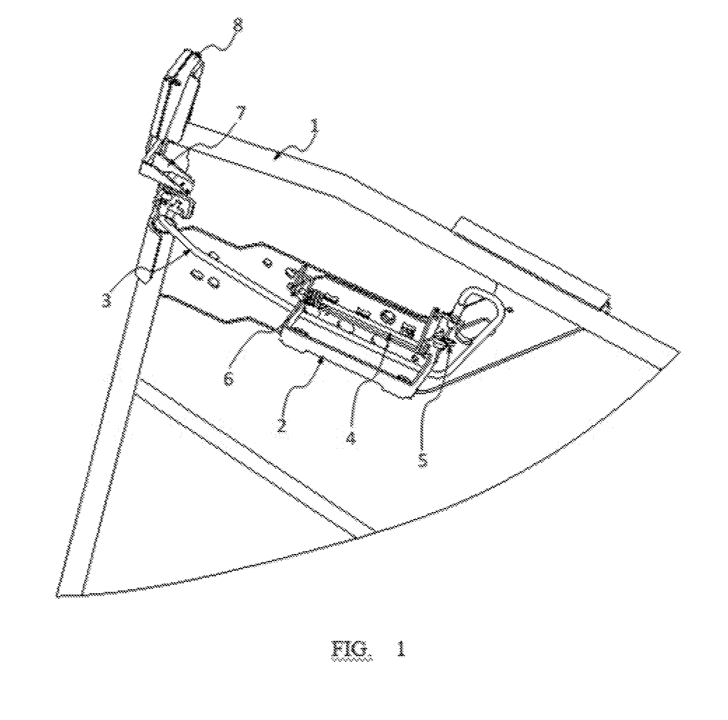

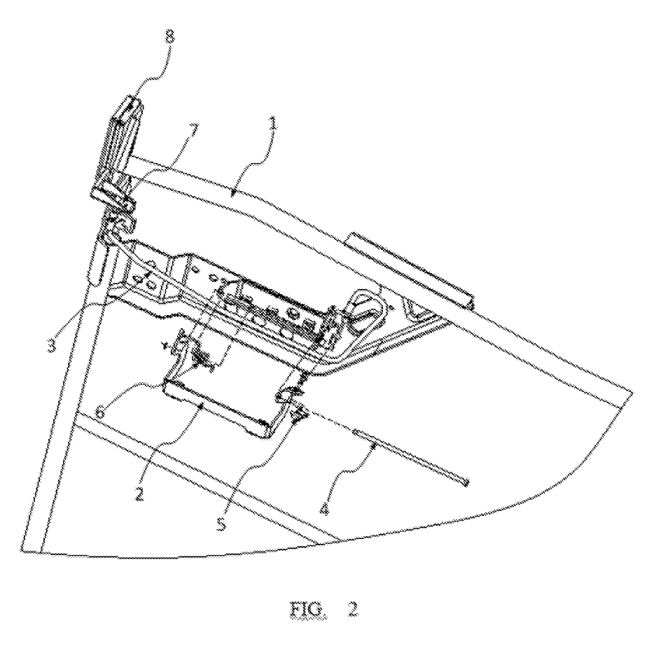

In FIGS. 1 and 2:

The door skeleton 1, the outer door handle 2, the cable 3, the shaft pin 4, the cable clip plate 5, the torsion spring 6, the movable lock pin 7, the door lock 8.

### DETAILED DESCRIPTION OF THE PREFERRED EMBODIMENTS

The first purpose of the present invention is to provide a type of outer door handle mechanism, its structure is designed in such a way that it can avoid the mutual interference with the inner door handle and reasonably make use of the space inside the door body. The second purpose of the present invention is to provide a type of vehicle and its door handle mechanism based on the outer door handle mechanism above.

Technical scheme of the embodiment of the present invention is clearly and completely described in the following combined with the accompanying drawings of the embodiment of the present invention; obviously, the embodiment of the present invention is a part of the embodiments, not all of the embodiments of the present invention. Based on the embodiment of the present invention, all other embodiments which the ordinary technical personnel in the art obtain at the premise of without giving creative labor are also deemed to fall into the protection scope of the present invention.

Referring to FIGS. 1 and 2, FIG. 1 is the schematic view showing the structure of the outer door handle mechanism provided by the embodiment of the present invention; FIG. 2 is the explosion view showing the structure of the outer door handle mechanism provided by the embodiment of the present invention.

A type of outer door handle mechanism provided by the present invention includes the door skeleton 1 and the outer door handle 2; wherein, the cable 3 and the door lock 8 are arranged on the door skeleton 1; one end of the cable 3 is connected to the movable lock pin 7 of the door lock 8; the outer door handle 2 is rotated and arranged on the outside of the door skeleton 1; one end of the outer door handle 2 is connected to the other end of the cable 3.

Compared with the prior art, in the outer door handle mechanism provided by the present invention, the outer door handle is connected to the door lock 8 by the cable 3 instead of connecting rod structure; the cable 3 can be arranged along any path and kept away from the inner door handle because of high flexibility and plasticity of the cable 3 relative to the connecting rod mechanism, which avoid the inner door handle interfering with the outer door handle 2 and the problem of difficult installation.

As shown in FIGS. 1 and 2, in the embodiment of the present invention, the outer door handle 2 is the U-shaped handle; the opening end of the U-shaped handle is rotated and connected to the door skeleton 1; one side of the opening end of the U-shaped handle is connected to the other end of the cable 3; the reset device is arranged between the other side of the opening end of the U-shaped handle and the door skeleton 1.

Of course, the above outer door handle 2 structure is only a referred embodiment provided by the present invention and is not limited to this in practice. The outer door handle 2 may also adopt such as plate structure, rod structure, etc, it is not limited herein.

In order to facilitate the connection between the cable and the U-shaped handle, in the embodiment of the present invention, the end part of the cable 3 is connected to the U-shaped handle by the cable clip plate 5; the U-shaped handle is provided with the connecting part; the connecting part is provided with the first pass opening that can be passed by the end head of the cable 3; the second pass opening is formed on the cable clip plate 5; the cable 3 core can be passed through the second pass opening and the end head of the cable 3 can not be passed through the second pass opening; the cable clip plate 5 is coordinated with the connecting part to make the second pass opening to be located on one side of the first pass opening. The cable clip plate 5 and the connecting part can be joined in a variety of ways, such as welding, clamping, threaded fastener connection, etc. Through the above structure, when assembled, first the end head of the cable 3 is passed through the first pass opening, then the second pass opening of the cable clip plate 5 is coordinated with the cable core of the cable 3 to make the cable clip plate 5 to be fixedly connected to one side where the connecting part is adjacent to the end head of the cable 3 or far away from the end head of the cable 3; the first pass opening is narrowed by the second pass opening to prevent the end head of the cable 3 from detaching from the connecting part.

Further optimization of the above technical scheme, in order to facilitate the alignment of the first pass opening with the second pass opening; in the embodiment of the present invention, for the cable clip plate 5 and the connecting part, one of them is provided with the limit slot for coordinating with the other, so the cable clip plate 5 and the connecting part are limited during the two of them coordinating with each other; in particular, as shown in FIGS. 1 and 2, the limit slot is arranged on the cable clamp plate 5 and formed by three end flanges of the cable clamp plate 5.

Referring to FIGS. 1 and 2; in this embodiment of the present invention, the U-shaped handle is rotated and arranged on the door skeleton 1 through the pin shaft 4; the pin shaft 4 is passed through both sides of the opening end of the U-shaped handle to make the U-shaped handle to be connected to the door skeleton 1; one end of the pin shaft 4 is provided with the limit cap and the other end is passed through the first side of the opening end of the U-shaped handle, the first through hole of the door skeleton 1 connection frame, the second through hole of the door skeleton 1 connection frame, and the second side of the opening end of the U-shaped handle in turn and assembled with the torsion spring to make the U-shaped handle to be connected to the door skeleton 1.

Further, on the basis of the above structure, the reset device is the torsion spring 6; the main body of the torsion spring 6 is mounted around the pin shaft 4; one of the two torsion arms of the torsion spring 6 is assembled with the door skeleton 1 and the other is assembled with the U-shaped handle.

Based on the above door handle mechanism the present invention also provides a type of door handle mechanism; it includes the outer door handle mechanism and the inner door handle mechanism and the two of them both adopt the cable as the transmission member. In particular, the door handle mechanism includes the door skeleton 1, the first cable 3, the second cable, the outer door handle 2 and the inner door handle; wherein, the door skeleton 1 is provided with the door lock 8 with the movable lock pin 7; the first cable and the second cable are arranged on the outer side of the door skeleton 1; one ends of the first cable and the second cable are connected to the movable lock pin 7; the inner door handle includes the holding part and the driving part fixedly attached to the holding part; the holding part is rotated and arranged on the inner side of the door skeleton 1; the driving part is connected to the other end of the first cable outside the door skeleton 1 through the door skeleton 1; the door handle 2 is rotated and arranged outside the door skeleton 1 and connected to the other end of the second cable.

In the above door handle mechanism, the outer door handle mechanism and the inner door handle mechanism both adopt the cable 3 as the transmission mechanism, which can greatly save the space inside the door to avoid the mutual interference between the outer door handle mechanism and the inner door handle mechanism to facilitate the assembly.

Further, the embodiment of the present invention also provides a type of vehicle the vehicle; it includes the outer door handle mechanism as described above, or the door handle mechanism as described above; that is, in this vehicle, not only the outer door handle mechanism can adopt the cable as the transmission member, but also the inner door handle mechanism and the outer door handle mechanism can adopt the cable 3 as transmission member. As the above outer door handle mechanism and inner door handle mechanism have the above technical effect, the vehicle provided with this outer door handle mechanism or inner door handle mechanism should also have the corresponding technical effect.

Each embodiment of the present specification is described in a progressive manner, and each embodiment focuses on the differences with other embodiment, the similar parts between the various embodiment can be referred from each other.

The above descriptions of the disclosed embodiment enable professional and technical personnel in the art to achieve or use the present invention. Obviously, the professional and technical personnel in the art will make a plurality of modifications to these embodiment, the general principles defined in this article may be achieve in the other embodiment without departing from the spirit or essential attributes of the present invention. Therefore, this present invention will not be limited to the embodiment shown in this article, but to conform to the maximum extent of principles and new features that are disclosed in this article.

1. A type of outer door handle mechanism is characterized in that it includes:
The door skeleton is provided with the cable and the door lock; one end of the said cable is connected to the movable lock pin of the said door lock;
The outer door handle is rotated and arranged on the outside of the said door skeleton; one end of the said outer door handle is connected to the other end of the said cable.

2. According to claim 1, the said outer door handle mechanism is characterized in that the said outer door handle is the U-shaped handle; the opening end of the said U-shaped handle is rotated and connected to the door skeleton; one side of the opening end of the said U-shaped handle is connected to the other end of the cable; the reset device is arranged between the other side of the opening end of the said U-shaped handle and the said door skeleton.

3. According to claim 2, the said outer door handle mechanism is characterized in that the other end of the said cable is connected to the said U-shaped handle through the cable clip plate; the said U-shaped handle is provided with the connecting part; the said connecting part is provided with the first pass opening that can be passed by the said cable end head; the second pass opening is formed on the said cable clip plate; the said cable core can be passed through the said second pass opening and the end head of the said cable can not be passed through the said second pass opening; the said cable clip plate is coordinated with the said connecting part to make the said second pass opening to be located on one side of the said first pass opening.

4. According to claim 3, the said outer door handle mechanism is characterized in that the limit slot is formed on the said cable clip plate; the said limit slot is coordinated with the said connecting part to make the said first pass opening and the said second pass opening to be aligned with each other.

5. According to claim 2, the said outer door handle mechanism is characterized in that the said U-shaped handle is rotated and arranged on the said door skeleton through the pin shaft; the said pin shaft is passed through both sides of the opening end of the said U-shaped handle to make the said U-shaped handle to be connected to the said door skeleton.

6. According to claim 5, the said outer door handle mechanism is characterized in that the said reset device is the torsion spring; the main body of the said torsion spring is mounted around the said pin shaft; one of the two torsion arms of the said torsion spring is assembled with the said door skeleton and the other is assembled with the said U-shaped handle.

7. A type of door handle mechanism is characterized in that it includes:
The door skeleton is provided with the door lock with the movable lock pin;
The first cable and the second cable are arranged on the outer side of the said door skeleton; one ends of the said first cable and the said second cable are both connected to the said movable locking pin;
For the inner door handle and the outer door handle, the said inner door handle includes the holding part and the driving part fixedly attached to the said holding part; the said holding part is rotated and arranged on the inner side of the door skeleton; the said driving part is passed through the said door skeleton and connected to the other end of the first cable outside the said door skeleton; the said outer door handle is rotated and arranged outside the said door skeleton and connected to the other end of the said second cable.

8. A type of vehicle is characterized in that it includes the outer door handle mechanism as described in any of the claim 1, or the door handle mechanism as described in claim 7.
